(19) United States
(12) Patent Application Publication
(10) Pub. No.: US 2008/0314479 A1
(43) Pub. Date: Dec. 25, 2008

(54) HIGH MANGANESE COBALT-MODIFIED ZINC PHOSPHATE CONVERSION COATING

(75) Inventor: Thomas Wilson Cape, West Bloomfield, MI (US)

Correspondence Address: HENKEL CORPORATION, 1001 TROUT BROOK CROSSING, ROCKY HILL, CT, 06067, US

(73) Assignee: Henkel AG & Co. KGaA, Duesseldorf (DE)

(21) Appl. No.: 12/135,520

(22) Filed: Jun. 9, 2008

Related U.S. Application Data
(60) Provisional application No. 60/942,507, filed on Jun. 7, 2007.

(51) Int. Cl. C23C 22/07; B32B 15/00

(52) U.S. Cl. 148/262; 148/22; 148/400

(57) ABSTRACT

Phosphate conversion coatings having very light color and excellent surface coverage with fine crystal size are obtained using liquid compositions containing phosphate, zinc cations, relatively high concentrations of Co and Mn, and low or no Ni.

This application claims priority to, and is a continuation of U.S. Provisional Patent Application No. 60/942,507, filed Jun. 7, 2007.

### FIELD OF THE INVENTION

This invention relates to the general field of phosphate conversion coating of metals and more particularly to phosphate coatings formed from a liquid phosphating composition that contains zinc and at least one of cobalt and manganese as layer forming cations at concentrations of cobalt and/or manganese greater than those found in conventional phosphating baths. The coatings formed from such a phosphating composition normally contain both zinc and at least the one(s) of cobalt and manganese also present in the phosphating compositions. The coatings formed may also contain iron and nickel, particularly if a ferriferous substrate such as ordinary (non-stainless) steel is being phosphated.

### BACKGROUND OF THE INVENTION

Phosphate layers with distinctly improved corrosion resistance and paint adhesion properties can be formed by using other polyvalent cations than zinc in the phosphating baths. For example, low-zinc processes where, for example, 0.5 to 1.5 g/1 manganese ions and, for example, 0.3 to 2.0 g/l nickel ions are added are widely used as so-called tri-cation processes.

Phosphating compositions with a high total concentration of divalent cations, such as divalent nickel, divalent cobalt, and divalent manganese (these three types of cations being hereinafter usually jointly referred to as “NCM” compositions) along with zinc, as taught in U.S. Pat. No. 4,681,641 of Jul. 21, 1987 to Zurilla et al., are also known. The conversion coatings formed by the use of such an NCM phosphating composition, when the composition has a very high nickel concentration, i.e. greater than 6 g/l, have smaller crystal sizes than do the coatings produced by almost any other kind of commonly used phosphating. The fine crystal size is desirable in phosphate coatings. Another benefit of high or very high nickel concentrations in the phosphating composition and presence in the coating is enhanced corrosion resistance. In conventional high NCM coatings, it is known that adequate corrosion resistance depends upon the presence of sufficient amounts of nickel and/or cobalt in the coating, i.e. totaling at least 2 wt %. “High NCM concentration” as used herein means concentrations of divalent metal cations of nickel, cobalt and manganese totaling greater than 6 g/l, and “high nickel concentration” as used herein means concentrations of nickel cations of 1-4 g/l.

However, phosphating processes with high nickel concentration compositions are also more prone to sludging and, when the total nickel content is very high, i.e. greater than 6 g/l, are much more prone to forming hard, heat-insulating scale on metal process equipment surfaces than almost any other type of commonly used phosphating composition.

A drawback of high nickel concentrations is the dark color of the coating produced. Requirements in industry for higher reflectance in coatings to reduce heat absorption have increased demand for lighter colored coatings. Heretofore, reducing the amount of nickel in the coating, to obtain a lighter colored coating, has not been possible due to deterioration of corrosion resistance of the coating and loss of fine crystal morphology provided by the nickel.

Accordingly, a major object of this invention is to provide phosphating compositions and/or processes that produce zinc phosphate conversion coatings with very fine crystal sizes comparable to those produced by previously known phosphating compositions containing very high nickel concentrations or high concentration NCM zinc phosphating compositions containing added nickel, but which are lighter in color than these conventional nickel containing phosphate coatings. Another object of the invention is to provide a metal substrate having thereon a phosphate coating containing zinc, cobalt and manganese deposited according to the invention.

Another object of the invention is to produce a working phosphating bath and a coating comprising low nickel concentrations, preferably no added nickel, while still achieving corrosion resistance comparable to or exceeding that of conventional coatings containing nickel such as NCM coatings.

Alternative and/or concurrent objects are to reduce, or at least not to exceed, the sludge formation and/or scaling obtained with previously used high nickel phosphating. Further more detailed alternative and/or concurrent objects will be apparent from the description below.

Except in the claims and the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, throughout this description, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description or of generation in situ by chemical reactions specified in the description, and does not necessarily preclude other chemical interactions among the constituents of a mixture once mixed; specification of materials in ionic form additionally implies the presence of sufficient counterions to produce electrical neutrality for the composition as a whole (any counterions thus implicitly specified should preferably be selected from among other constituents explicitly specified in ionic form, to the extent possible; otherwise such counterions may be freely selected, except for avoiding counterions that act adversely to the objects of the invention); the term “paint” and all of its grammatical variations are intended to include any similar more specialized terms, such as “lacquer”, “varnish”, “electrophoretic paint”, “top coat”, “color coat”, “radiation curable coating”, or the like and their grammatical variations; and the term “mole” means “gram mole”, and “mole” and its grammatical variations may be applied to elemental, ionic, and any other chemical species defined by number and type of atoms present, as well as to compounds with well defined molecules.

### SUMMARY OF THE INVENTION

Conventional thinking regarding NCM processes has been that nickel, cobalt and manganese were all beneficial together in the bath. Applicant has found that these divalent cations act in competition with each other and are in fact not always beneficial to coating formation. In particular, high Mn in the presence of Ni inhibits phosphate conversion coating formation and results in a poor performing coating. Applicant has found that high Mn in the presence of Co does not inhibit phosphate coating formation as much resulting in good adhesion and corrosion resistance.

The presence of nickel in a conversion coating results in darker coatings than the presence of an equal amount of cobalt substituted for the nickel in the same conversion coating. Up to now, cobalt had been considered as equivalent to nickel in its functioning in phosphate conversion coating formation. Since manganese in the presence of nickel interfered with coating formation it was not considered to substitute cobalt for nickel in coating baths, as the same poor coating formation was expected. Applicant has found that reducing the amount of nickel used in phosphating compositions while increasing the concentrations of cobalt and manganese to amounts higher than found in an otherwise conventional zinc phosphating composition resulted in the desired lighter colored conversion coatings with the unexpected feature of a complete and adherent phosphate conversion coating previously obtainable only with nickel concentrations of greater than 1 μl and low manganese concentrations of less than 4 g/l.

An unexpected benefit of using cobalt as a replacement for some or all of the nickel at higher manganese concentrations of greater than about 4.0 g/l, preferably greater than about 4.5 μl, more preferably greater than about 5.0 μl, is desirable morphology changes in the resulting coating. The coating provides complete coverage with a fine crystal structure of about 1-3 microns. In one embodiment, the fine crystal structure is nodular.

Compared to nickel-manganese-modified zinc phosphating baths of the prior art, cobalt-manganese-modified zinc phosphating baths of the invention provide more complete coatings. Specifically, the coatings resulting from higher manganese levels of greater than 4.5 g/l in the phosphating bath display small tightly packed crystals and these crystals have fewer voids between them than the conventional coatings. Compared to nickel-modified or nickel-free zinc phosphate baths with lower cobalt and/or manganese levels, coating derived from Applicant's zinc phosphating baths provide improved adhesion and corrosion protection.

The ability to coat metal with phosphating compositions at higher manganese levels is new and surprising. Previous work showed an upper limit of 1-4 g/l for manganese in zinc phosphating baths, which limit is lower than the amounts of manganese that can be incorporated into Applicant's bath chemistry. In conventional high or very high nickel phosphating baths, increasing the Mn level to amounts greater than 4 g/1 Mn cations resulted in poor coating formation, namely incomplete coverage of the substrate and poor subsequent paint adhesion. Applicant has found that reducing the nickel concentration and substituting therefor cobalt cations allows the amount of Mn cations to be increased in practice to at least about 4.5 g/l and desirably to as much as 9 g/l.

Applicant's phosphating baths, including higher levels of manganese and cobalt provide zinc phosphate coatings with high corrosion protection that are lighter colored and hence more economically competitive than darker colored high nickel zinc phosphate baths.

Compared to high nickel baths or nickel-manganese baths, the phosphating baths of the invention comprising cobalt and high manganese produce zinc phosphate coatings that, when painted, provide a lighter color and higher reflectance while maintaining high painted corrosion protection. The lighter color allows the coil coater to have fewer paints held in inventory and the end customer access to more pleasing colors. The higher reflectance allows more dark colors to meet cool roof reflectance standards. The higher reflectance and lighter color are a primary impetus for the work leading to this discovery.

Embodiments of the invention include working aqueous liquid compositions suitable for contacting directly with metal surfaces to provide conversion coatings thereon; liquid or solid concentrates that will form such working aqueous liquid compositions upon dilution with water only or, optionally with addition of other ingredients; processes of using working aqueous liquid compositions according to the invention as defined above to form protective coatings on metal surfaces and, optionally, to further process the metal objects with surfaces so protected; protective solid coatings on metal surfaces formed in such a process; and metal articles bearing such a protective coating.

### DETAILED DESCRIPTION OF THE INVENTION

A working composition according to the invention preferably comprises, more preferably consists essentially of, or still more preferably consists of, water and the following components:
(A) sufficient dissolved phosphate anions to deposit a zinc phosphate coating;
(B) 0.8-4.0 g/L dissolved cobalt cations;
(C) 1.0-2.5 g/L dissolved zinc cations; and
(D) 4.5-9.0 g/L dissolved manganese cations;
   Optionally, one or more of the following components may also be present:
(E) a phosphating accelerator that is not part of any of components (A) through (D) as recited immediately above;
(F) dissolved chelating molecules (for divalent metal cations) that are not part of any of components (A) through (E) as recited immediately above;
(G) an acidity adjustment agent that is not part of any of components (A) through (F) as recited immediately above;
(H) dissolved fluoride ions that are not part of any of components (A) through (E) as recited immediately above;
(J) dissolved iron cations and/or dissolved nickel cations, said nickel cations preferably having a concentration of less than <0.5 g/l, most preferably <0.1 g/l; and
(K) sludge conditioner that is not part of any of components (A) through (J) as recited immediately above.

Additional optional components may also be present.

In one embodiment, no nickel is added to the phosphating composition and the nickel concentration in the bath is minimized. During phosphating of some metals, for example steel, etching of the substrate during the conversion coating reaction leads to introduction of minor amounts of nickel, such baths having no added nickel, but which contain nickel from the substrate should be considered as included in the compositions of this invention. In a preferred embodiment the concentration of nickel cations in the working bath is not more than in increasing order of preference 0.5, 0.4, 0.3, 0.2, 0.1, 0.05, 0.025, 0.01, 0.005, 0.0025, 0.001, 0.0005 or 0.0001 g/l.

The weight ratio of manganese to cobalt ranges from 1.0:1.0 to 20:1; desirably the ratio is from 1.0:1.0 to 13.0:1.0. In one embodiment, the ratio of manganese to cobalt is from about 2:1 to about 10:1 and desirably, the ratio is from about 3:1 to about 6:1.

In another embodiment of the invention, the ratio of cobalt to zinc is such that the concentration of cobalt is greater than 50% of the concentration of zinc.

In a composition according to the invention, component (A) preferably, at least for economy, is sourced to a composition according to the invention by at least one of orthophosphoric acid and its salts of any degree of neutralization. Component (A) can also be sourced to a composition according to the invention by pyrophosphate and other more highly condensed phosphates, including metaphosphates, which tend at the preferred concentrations for at least working compositions according to the invention to hydrolyze to orthophosphates. However, inasmuch as the condensed phosphates are usually at least as expensive as orthophosphates, there is little practical incentive to use condensed phosphates, except possibly to prepare extremely highly concentrated liquid compositions according to the invention, in which condensed phosphates may be more soluble.

Whatever its source, the concentration of component (A) in a working composition according to the invention, measured as its stoichiometric equivalent as H₃PO₄ with the stoichiometry based on equal numbers of phosphorus atoms, preferably is at least, with increasing preference in the order given, 0.2, 0.4, 0.6, 0.70, or 0.75% and independently preferably is not more than, with increasing preference in the order given, 20, 10, 6.5, 5.0, 4.0, 3.5, 3.0, 2.0, 1.8, 1.6, or 1.4%. If the phosphate concentration is too low, the rate of formation of the desired conversion coating will be slower than is normally desired, while if this concentration is too high, the cost of the composition will be increased without any offsetting benefit, the metal substrate may be excessively etched, and the quality of the phosphate coating formed may be poor.

Component (B) of dissolved cobalt cations is preferably sourced to the composition as at least one nitrate or phosphate salt (which may of course be prepared by dissolving the elemental metal and/or an oxide or carbonate thereof in acid), although any other sufficiently soluble cobalt salt may be used. The entire cobalt cations content of any water-soluble cobalt salt dissolved in a composition according to the invention is presumed to be cobalt cations in solution, irrespective of any coordinate complex formation or other physical or chemical bonding of the cobalt cations with other constituents of the composition according to the invention. Salts containing divalent cobalt are preferred over those containing trivalent cobalt. Independently of their source, the concentration of cobalt cations in a working composition according to the invention preferably is at least, with increasing preference in the order given, 0.70, 0.75, 0.8, 0.85, 0.9, 0.95, or 0.97 g/l of total composition, and independently preferably is not more than, with increasing preference in the order given, 4.00, 3.75, 3.50, 3.25, 3.00, 2.80, 2.60, 2.50, 2.40, 2.30, 2.20, 2.00, 1.80, 1.60, 1.50, 1.40, 1.30, 1.20, 1.10, or 1.00 g/l. If the concentration of cobalt is too low, a refined crystal structure will not usually be achieved, while if this concentration is too high, the cost of the composition will increase without any corresponding increase in performance.

Zinc cations for component (C) are preferably sourced to a composition according to the invention from at least one zinc phosphate salt, at least one zinc nitrate salt, and/or by dissolving at least one of metallic zinc, zinc oxide, and zinc carbonate in a precursor composition that contains at least enough phosphoric and/or nitric acid to convert the zinc content of the oxide to a dissolved zinc salt. However, these preferences are primarily for economy and availability of commercial materials free from amounts of impurities that adversely affect phosphating reactions, so that any other suitable source of dissolved zinc cations could also be used. The entire zinc content of any salt or other compound dissolved or reacted with acid in a composition according to the invention is to be presumed to be present as cations when determining whether the concentration of zinc cations satisfies a concentration preference as noted below.

In any working composition according to the invention, the concentration of zinc cations preferably is at least, with increasing preference in the order given, 0.70, 0.75, 0.8, 0.85, 0.9, 0.95, 1.0, 1.1, 1.2, 1.3, 1.4, 1.5, 1.6, 1.7, or 1.75 g/l dissolved zinc cations; and independently preferably is not more than, with increasing preference in the order given, 3.0, 2.80, 2.60, 2.50, 2.40, 2.30, 2.20, 2.10, 2.0, 1.95, 1.9, 1.85, or 1.80 g/l. If the zinc concentration is either too low or too high, the corrosion-protective quality of the coating is likely to be inferior, and if this concentration is too low, the rate of coating formation also is likely to be slower than desirable.

Component (D) of manganese cations is preferably sourced to a phosphating composition according to the invention by a nitrate or phosphate salt of these metals, the divalent cations of each metal being preferred. The entire content of the metal in any water soluble salt dissolved, or any elemental metal, metal oxide, or the like reacted with acid to form an aqueous solution in the course of preparing a composition according to the invention, is to be considered as free cations for determining whether the concentration conforms to preferences given below.

The concentration of manganese cations preferably is at least, with increasing preference in the order given, 3.0, 3.1, 3.2, 3.3, 3.4, 3.5, 3.6, 3.70, 3.75, 3.8, 3.85, 3.9, 3.95, 3.97, 4.0, 4.1, 4.2, 4.3, 4.4, 4.5, 4.6, 4.70, 4.75, 4.8, 4.85, 4.9, 5.0, 5.1, 5.2, 5.3, 5.4, 5.5, 5.6, 5.70, 5.75, 5.8, 5.85, 5.9, 6.0, 6.5 g/L and independently preferably is not more than, with increasing preference in the order given, 9.0, 8.80, 8.60, 8.50, 8.40, 8.30, 8.20, 8.00, 7.80, 7.60, 7.50, 7.40, 7.30, 7.20, 7.10, or 7.00 g/l.

If the concentration of component (D) is too low, the rate of formation of the coating will usually be slower than is desirable, unless the concentration of zinc is high, and in that instance, or if the concentration of manganese is too low, the corrosion-protective value of the coating will be sub-optimal. If the concentration of component (D) as a whole or of either nickel or manganese is too high, the cost will be increased without any offsetting benefit.

Optional component (E) of conversion coating accelerator preferably is present in a composition according to the invention, because without this component the coating formation rate usually is slower than is desired. The accelerator (or more than one accelerator) when present in a working composition according to the invention preferably is selected from the group consisting of: chlorate ions (preferably, 0.3 to 4 parts per thousand parts of total phosphating composition, this unit of concentration being freely used hereinafter for any constituent of the composition and being hereinafter usually abbreviated as “ppt”), nitrite ions (preferably, 0.01 to 0.2 ppt); m-nitrobenzene sulfonate ions (preferably, 0.05 to 2 ppt); m-nitrobenzoate ions (preferably, 0.05 to 2 ppt); p-nitrophenol (preferably, 0.05 to 2 ppt); hydrogen peroxide in free or bound form (preferably, 0.005 to 0.15 ppt); hydroxylamine in free or bound form (preferably, 0.02 to 10 ppt); a reducing sugar (preferably, 0.1 to 10 ppt); nitroguanidine; and nitrate ions. Nitrate ions are preferred within this group. Nitrate ions are preferably sourced to the composition by at least one of nitric acid and its salts. When nitrate ions are present in a working composition according to the invention, their concentration more preferably is at least, with increasing preference in the order given, 0.001, 0.005, 0.010, or 0.020% and independently preferably is not more than, with increasing preference in the order given, 8.0, 6.0, 4.0, 3.0, 2.5, 2.0, or 1.7%. If the concentration of nitrate is too high, the danger of emissions of noxious oxides of nitrogen from the phosphating composition is increased, while if this concentration is too low, the rate of formation of the phosphate coating will usually be slower than desirable, and the corrosion-protective quality of the coating may be poor.

A composition according to the invention may contain hydroxylamine as an accelerator, in an amount that preferably is at least, with increasing preference in the order given, 1, 5, or 8 ppm and independently preferably is not more than, with increasing preference in the order given, 300, 200, 150, 125, 100, 90, 80, 70, 65, 60, 55, 50, or 45 ppm. As is usual in phosphating compositions in which hydroxylamine is used, it is preferably supplied to the composition in the form of a salt, complex, or even a hydrolysable compound such as an oxime, because pure hydroxylamine is chemically unstable. The entire stoichiometric equivalent as pure hydroxylamine of any such “bound” form of hydroxylamine sourced to the composition is to be considered as hydroxylamine in assessing conformance to the concentration preferences stated above. The single most preferred source, primarily for economy and ready commercial availability, is hydroxylamine sulfate.

The presence of optional component (F) of dissolved chelating molecules in a composition according to the invention is preferred when water with any significant hardness is expected to be used in making up a working composition according to the invention. Calcium and/or magnesium cations, usually present in hard water, can precipitate phosphate as sludge and/for become incorporated into the phosphate coating, both possibilities being generally undesirable. These potential difficulties can be prevented by including in the composition chelating molecules that can form strong coordinate bonds to calcium and magnesium cations. The chelating molecules are preferably selected from organic molecules each of which contains at least two moieties selected from the group consisting of carboxyl, other hydroxyl, carboxylate, phosphonate, and amino, these moieties being arranged within the molecules selected so that a five- or six-membered ring, including a chelated metal atom and two nucleophilic atoms in the chelating molecule, can be formed by chelation. For convenience and economy at least, the chelating agent when used preferably is selected from the group consisting of tartaric acid, maleic acids citric acid, gluconic acid, and salts of all of these acids.

A phosphating composition according to this invention is necessarily acidic. Its acidity is preferably measured for control and optimization by two characteristics familiar in the art as “points” of Free Acid (hereinafter usually abbreviated as “FA”) and of Total Acid (hereinafter usually abbreviated as “TA”). Either of these values is measured by titrating a 10.0 milliliter sample of the composition with 0.100 strong alkali. If FA is to be determined, the titration is to an end point of pH 3.8 as measured by a pH meter or an indicator such as bromcresol green or bromthymol blue, while if TA is to be determined, the titration is to an end point of pH 8.0 as measured by a pH meter or an indicator such as phenolphthalein. In either instance, the value in points is defined as equal to the number of milliliters of the titrant required to reach the end point.

A working phosphating composition according to this invention preferably has an FA value that is at least, with increasing preference in the order given, 0.3, 0.5, 0.8, 1.0, 1.3, 1.6, 1.9, 2.1, 2.3, 2.5, 27, 2.9, 3.1 or 3.3 points and independently preferably is not more than, with increasing preference in the order given, 10, 8, 6.0, 5.0, 4.5, 4.0, 3.7, or points. Also and independently, a working phosphating composition according to the invention preferably has a TA value that is at least, with increasing preference in the order given, 13, 16, 19, 21, 23, or 25 points and independently preferably is not more than, with increasing preference in the order given, 50, 40, 36, 34, 32, or 30 points. If either the FA or the TA value is too low, the phosphating coating formation will be lower than is usually desired, while if either value is too high there may be excessive dissolution of the substrate and/or suboptimal crystal morphology in the coating formed. Ordinarily, the FA and TA values can be brought within a preferred range by use of appropriate amounts of acidic sources of phosphate, nitrate, and/or complexed fluoride and basic sources of zinc and/or NCM, but if needed, optional component (G) preferably is used to bring the composition within a preferred range of both TA and FA. Alkali metal hydroxides, carbonates, and/or oxides are preferably used for this purpose if alkalinity is needed, and phosphoric acid and/or nitric acid is preferably used if acidity is needed.

The presence of optional component (H) of dissolved fluoride in a composition according to the invention is preferred in some phosphating operations, by way of non-limiting example when phosphating aluminum or an alloy that contains a substantial fraction of aluminum, because without fluoride present the accumulation of aluminum cations in the phosphating composition will quickly reduce the effectiveness of the composition. When fluoride is present in sufficient quantity, aluminum cations form complex anions with the fluoride ions, and a much larger concentration of aluminum in anionic form than in cationic form can be present without harming the effectiveness of the phosphating composition. If substantial amounts of chloride are present in the phosphating composition, as may readily occur when the water supply used is high in chloride and/or when some of the active ingredients contain chloride as an impurity, and a predominantly zinciferous surface is being phosphated, the presence of dissolved fluoride in a composition according to the invention is also preferred, in order to minimize the danger of forming the small surface blemishes known in art as “white specking”, “seediness”, or the like. In most other instances, however, fluoride is not needed and when not needed is preferably omitted.

When fluoride is present in a phosphating composition according to this invention, it preferably is sourced to the composition in two differing forms: “uncomplexed fluoride” supplied by hydrofluoric acid and/or one of its salts (which may be partially or totally neutralized); and “complexed fluoride” supplied to the composition by at least one of the acids HBF₄, H₂SiF₆, H₂TiF₆, H₂ZrF₆, and H₂HfF₆, and their salts (which also may be partially or totally neutralized). Among this group, H₂SiF₆ and its salts are most preferred, the acid itself being usually preferred for economy and ready commercial availability. Uncomplexed fluoride promotes etching of the substrate being phosphated and therefore can not be present in too large a concentration without damaging the effectiveness of the phosphating process. The presence of complexed fluoride is believed to result in a “free fluoride buffering” effect: As originally uncomplexed fluoride is consumed by complexing aluminum cations introduced into the phosphating composition by its use on an aluminiferous substrate, the originally complexed fluoride partially dissociates to maintain its equilibrium with free fluoride and thereby provides more capacity for complexing additional aluminum ions.

When both uncomplexed and complexed fluorides are present in a working phosphating composition according to the invention, the concentration of complexed fluoride in the phosphating composition preferably is at least, with increasing preference in the order given, 0.25, 0.50, 1.0, or 1.5 ppt and independently preferably is not more than, with increasing preference in the order given, 20, 15, 10.0, 7.0, 5.0, or 4.0 ppt; independently, the concentration of uncomplexed fluoride in the phosphating composition preferably is at least, with increasing preference in the order given, 0.05, 0.10, 0.15, 0.20, 0.25, or 0.30 and independently preferably is not more than, with increasing preference in the order given, 7.0, 6.0, 5.0, 4.5, 3.5, 2.5, 2.0, 1.5, or 1.0; and, independently, the ratio of uncomplexed fluoride to complexed fluoride preferably is at least, with increasing preference in the order given, 0.02:1.00, 0.04:1.00, 0.06:1.00, 0.08:1.00, 0.10:1.00, 0.12:1.00, or 0.14:1.00 and independently preferably is not more than, with increasing preference in the order given, 2.0:1.00, 1.5:1.00, 1.00:1.00, 0.80:1.00, 0.50:1.00, 0.45:1.00, or 0.40:1.00.

If a phosphating composition according to the invention contains either fluoride only in uncomplexed form or fluoride only in complexed form, the total fluoride content of the composition preferably is at least, with increasing preference in the order given, 0.05 or 0.10 ppt and independently preferably is, with increasing preference in the order given, not more than 20, 15, 10, 7, or 5 ppt.

It has surprisingly been found that the presence of iron cations can reduce the formation of scale and/or sludge, even when a phosphating composition is maintained at a high temperature. Therefore, if either scaling or sludging is a problem in a process according to this invention when no iron cations are present, inclusion of optional component (J) of iron cations to reduce this problem is generally preferred. When used, iron cations are preferably sourced to a phosphating composition according to the invention by a source of iron(III) ions, most preferably ferric nitrate, although other water-soluble sources of ferric ions may be used. The solubilities of ferric phosphate and of ferric hydroxide are rather low in the presence of preferred amounts of other constituents of a preferred phosphating composition according to this invention, and when iron cations are included in a working phosphating composition according to the invention the concentration of the iron cations preferably is at least, with increasing preference in the order given, 40, 60, 80, or 100% of its saturation level. Saturation is believed to correspond to about 10 ppm. In order to assure maintenance of the most preferred fully saturated concentration of dissolved iron cations, it is preferred to provide to a phosphating composition according to the invention an amount of total ferric salt that contains at least, with increasing preference in the order given, 20, 30, 40, 50, or 60 ppm of iron cations, most of which remains undissolved unless and until some of the dissolved ferric ions are removed from the composition by drag-out, precipitation as sludge, or the like.

Optional component (K) of sludge conditioner is not always needed in a composition according to the invention and therefore is preferably omitted in such instances. However, in many instances, at least one such conditioner may be advantageously used, in order to make separation and collection of any sludge that forms easier. In any such instances, suitable material for these purposes can be readily selected by those skilled in the art. Examples include natural gums such as xanthan gum, urea, and surfactants such as sodium 2-ethylhexyl sulfonate.

For various reasons, almost always including at least a cost saving from elimination of an unnecessary ingredient, it is preferred that a composition according to this invention should be largely free from various materials often used in prior art compositions. In particular, compositions according to this invention in most instances preferably do not contain, with increasing preference in the order given, and with independent preference for each component named, more than 5, 4, 3, 2, 1, 0.5, 0.25, 0.12, 0.06, 0.03, 0.015, 0.007, 0.003, 0.001, 0.0005, 0.0002, or 0.0001% of each of (i) dissolved unchelated calcium and magnesium cations, (ii) dissolved copper cations, (iii) dissolved aluminum, and (iv) dissolved chromium in any chemical form.

In addition to and independently of the specific preferred concentrations for various components certain ratios of some of the components are preferred. More specifically, independently for each:

the ratio of % of zinc to % of orthophosphoric acid (stoichiometric equivalent) preferably is at least, with increasing preference in the order given, 0.01:1.00, 0.02:1.00, 0.03:1.00, or 0.04:1.00, and independently preferably is not more than, with increasing preference in the order given, 1.0:1.00, 0.8:1.00, 0.6:1.00, 0.50:1.00, 0.40:1.00, or 0.35:1.00;

the ratio of % nitrate anions to % phosphoric acid (stoichiometric equivalent) preferably is at least, with increasing preference in the order given, 0.1:1.00, 0.2:1.00, 0.3:1.00, 0.4:1.00, or 0.5:1.00 and independently preferably is not more than, with increasing preference in the order given, 5.0:1.00, 4.0:1.00, 3.0:1.00, 2.5:1.00, 2.0:1.00, 1.8:1.00, 1.6:1.00, or 1.50:1.00,

Preferred concentrations have been specified above for working compositions according to the invention, but another embodiment of the invention is a make-up concentrate composition that can be diluted with water only, or with water and an acidifying or alkalinizing agent only, to produce a working composition, and the concentration of ingredients other than water in such a concentrate composition preferably is as high as possible without resulting in instability of the concentrate during storage. A high concentration of active ingredients in a concentrate minimizes the cost of shipping water from a concentrate manufacturer to an end user, who can almost always provide water more cheaply at the point of use. More particularly, in a concentrate composition according to this invention, the concentration of each ingredient other than water preferably is at least, with increasing preference in the order given, 2, 4, 6, 8, 10, 12, 14, 16, or 18 times as great as the preferred minimum amounts specified above for working compositions according to the invention; independently, the concentration of each ingredient other than water preferably is not more than, with increasing preference in the order given, 50, 40, 35, 30, 25, 23, 21, or 19 times as great as the preferred maximum amounts specified above for working compositions according to the invention. (The Free Acid and Total Acid “points” are not ingredients in this sense, because these values depend on interactions among various constituents and do not scale linearly on dilution as do the concentrations of specific ingredients such as zinc ions or nitrate ions.) In addition to the concentrations recited above, a make-up concentrate preferably has the same ratios between various ingredients as are specified for working compositions above.

A phosphating composition according to the invention is preferably maintained while coating a metal substrate in a process according to the invention at a temperature that is at least, with increasing preference in the order given, 35, 45, 50, 53, 56, or 59° C. and independently preferably is not more than, with increasing preference in the order given, 85, 80, 78, 76, 74, or 72° C.

The specific areal density (also often called “add-on weight [or mass]”) of a phosphate coating formed according to this invention preferably is at least, with increasing preference in the order given, 0.3, 0.6, 0.8, 1.0, or 1.2 grams of dried coating per square meter of substrate coated, this unit of coating weight being hereinafter usually abbreviated as “g/m²”, and independently preferably is not more than, with increasing preference in the order given, 6.0, 5.0, 4.5, 4.0, 3.5, 3.0, or 2.5 g/m². The phosphate conversion coating weight may be measured by stripping the conversion coating in a solution of chromic acid in water as generally known in the art.

Before treatment according to the invention, metal substrate surfaces preferably are conventionally cleaned, rinsed, and “conditioned” with a Jernstedt salt or an at least similarly effective treatment, all in a manner well known in the art for any particular type of substrate; and after a treatment according to the invention the composition according to the invention generally should be rinsed off the surface coated before applying a sealing rinse and drying or just drying. The treatment can consist of exposing the metal surface to the solution at sufficient temperature to effect treatment. For treatment times typical of modern coil lines the phosphating process can be completed at 50° C. to 75° C. with this invention. Exposure of the metal strip to the phosphating solution can consist of either spray or immersion application.

This invention is particularly advantageously, and therefore preferably, used on zinciferous metal substrates, such as galvanized steel of all kinds and zinc-tin, zinc-magnesium and zinc-aluminum alloys, or more generally any metal alloy surface that is at least 55% zinc. Further and independently, this invention is particularly advantageously, and therefore preferably, used when it is desired to complete formation of a phosphate conversion coating very rapidly, specifically in not more than, with increasing preference in the order given, 45, 30, 25, 20, 15, 10, or 5 seconds of contact time between the substrate metal being treated and a liquid phosphating composition according to the invention. Such short contact times are particularly likely to be economically required in the processing of continuous coil stock.

The practice of this invention may be further appreciated by consideration of the following, non-limiting, working examples, and the benefits of the invention may be further appreciated by reference to the comparison examples.

### EXAMPLES

### Example 1

A set of formulations (four comparative formulations and two formulations according to the invention) has been evaluated. Table 1 contains the chemistry of the concentrates. Separate concentrates of Formulations A-F were made-up as recited in Table 1.

TABLE 1
Concentrate Chemistries of Formulations and Comparative Formulations

| | Formulations (Comparative) | | | | Formulations | | Mix |
|---|---|---|---|---|---|---|---|
| Ingredients (g) | A | B | C | D | E | F | Directions |
| Water | 200.33 | 260.13 | 316.93 | 278.47 | 311.75 | 226.45 | Add and |
| 75% Phosphoric Acid | 267.14 | 267.14 | 267.14 | 128.00 | 270.24 | 314.44 | Mix |
| 67% Nitric Acid | 116.6 | 116.60 | 149.20 | 0.00 | 152.40 | 116.60 | |
| 49% Hydrofluoric Acid | 16.00 | 16.00 | 16.00 | 11.43 | 16.00 | 16.00 | |
| 10% Zinc acid Phosphate | 72.01 | 72.01 | 72.01 | 49.00 | 72.01 | 72.01 | |
| HAS | 5.17 | 10.33 | 15.50 | 0.00 | 15.50 | 15.50 | |
| Manganese Oxide | 25.83 | 51.67 | 77.50 | 0.00 | 77.50 | 77.50 | Disperse |
| 14% Nickel Nitrate | 144 | 144.00 | 72.00 | 159.50 | 0.00 | 0.00 | Add and |
| 8% Nickel Phosphate | 0.00 | 0.00 | 0.00 | 331.00 | 0.00 | 0.00 | Mix |
| 13% Cobalt Nitrate | 6.12 | 6.12 | 6.12 | 0.00 | 77.00 | 153.90 | |
| Ferric nitrate | 7.6 | 7.60 | 7.60 | 7.60 | 7.60 | 7.60 | Dissolve |
| Monosodium Phosphate | 0.00 | 0.00 | 0.00 | 30.00 | 0.00 | 0.00 | |
| 45% Potassium | 139.2 | 48.40 | 0.00 | 5.00 | 0.00 | 0.00 | Add slowly |
| Hydroxide | | | | | | | |

Working baths were made using the concentrates of Table 1 for each of Formulations A-F at 7% volume/volume and neutralized to a Free Acid of 3.8 with sodium carbonate. The amount of Ni, Co and Mn in each of the working baths is provided in Table 2.

Panels of hot-dipped galvanized (HDG) steel, commercially available from ACT Corporation, were treated and coated according to the following procedure:
1. Cleaned with Parco Cleaner 1200, commercially available from Henkel Corp., at 140° F. for 10 seconds;
2. Rinsed with warm water for 5-10 seconds;
3. Activated with Parcolene AT, commercially available from Henkel Corp., at 120° F. for 1-2 seconds;
4. Treated with a working bath according to Table 2 at a temperature of 150° F. for 5 seconds;
5. Rinsed with warm water for 5-10 seconds.

The coating chemistry of the coated panels was tested by stripping the coating from the panel with HCl and measuring the concentration of each metal ion above a control amount found in an uncoated panel by inductively coupled plasma (ICP). The amounts (wt %) of Ni, Co and Mn in coatings produced by each of the working baths are recited in Table 2.

Coating color was assessed based on the standard measures for color known in the art: L, a and b, where L is a measure of lightness with 0=black and 100=white, a is the green/red scale with −65=green and +65=red, and b is the blue/yellow scale with −65=blue and +65=yellow. Coating color was measured using a commercially available calorimeter calibrated according to the manufacturer's requirements. Reflectance (scale is zero to 1) of the coatings was measured on a D&S reflectometer from Oak Ridge National Laboratories. Scanning electron micrographs were taken of the various panels coated and crystal size and morphology was noted. Crystal size for Formulations E & F was similar to the high nickel fine crystal morphology of Formulation D.

TABLE 2
Properties of Formulations and Comparative Formulations

| | | Comparative Formulations | | | | Formulations | |
|---|---|---|---|---|---|---|---|
| Property | | A | B | C | D | E | F |
| Bath Chemistry at | Ni | 2.0 | 2.0 | 1.0 | 6.4 | 0.0 | 0.0 |
| 10% Make up | Co | 0.08 | 0.08 | 0.08 | 0.00 | 1.0 | 2.0 |
| (in g/L) | Mn | 2.0 | 4.0 | 6.0 | 0.0 | 6.0 | 6.0 |
| Coating Chemistry | Ni | 1.6% | 0.6% | 1.1% | 3.6% | <0.1% | <0.1% |
| | Co | <0.1% | <0.1% | <0.1% | 0.0% | 0.6% | 1.6% |
| | Mn | 4.6% | 5.1% | 5.8% | 0.0% | 7.1% | 6.6% |
| Coating Color | L | 51 | 62 | 48 | 48 | 77 | 75 |
| | a | 1.2 | 0.0 | 1.5 | 1.0 | 2.1 | 1.7 |
| | b | 9.6 | 8.5 | 8.3 | 7.8 | 1.5 | 2.6 |

| | | | | | | |
|---|---|---|---|---|---|---|
| Reflectance | | | | 0.22 | 0.51 | 0.44 |
| Scanning Electron Micrograph | Good | Complete | Coating | Good | Fine | Fine |
| | coating | coating | not | coating | nodular | nodular |
| | appear. | poorly | complete | appear. | crystal; | crystal; |
| | | formed | | | complete | complete |
| | | crystals | | | coating | coating |

The results in Table 2 show the effect of even small amounts of nickel in a coating bath upon coating color and the incorporation of manganese into the coating. While Comparative Formulation C has a manganese concentration of 6 g/l in the bath, similar to Formulations E and F of the invention, the amount of manganese in the coating is significantly less in Formulation C than in Formulations E and F. The effect of nickel on the coating color from similar compositions is also notable. The absence of nickel in Formulations E and F increases the “L” value as compared to Comparative Formulation C by 50%. The yellow tones are also significantly lower for Formulations E and F as compared to Comparative Formulation C.

### Example 2

Panels coated according to the procedure of Example 1, using Formulations A-F and commercially available formulations, as well as a cleaned unphosphated control panel, were subjected to the following additional treatment steps:
6. Sealed with Commercial Sealing Rinse 3 or Commercial Sealing Rinse 4;
7. Primed with a commercially available primer paint (as recited below) and baked;
8. Topcoated with a commercially available topcoat (as recited below) and baked.

The panels were then subjected to ASTM B117 Neutral Salt Spray testing. Table 3 shows the salt spray results of painted panels.

TABLE 3
1008 hr. Salt Spray Test*

| | Valspar ® Paint System | | | | AKZO ® Paint System | | | | | |
|---|---|---|---|---|---|---|---|---|---|---|
| | Edge | | Scribe | | Edge | | Scribe | | Average | |
| Treatments | I | II | I | II | I | II | I | II | Edge | Scribe |
| None | 10.0 | 7.7 | 1.1 | 0.1 | 11.0 | 5.1 | 0.3 | 0.6 | 8.5 | 0.5 |
| Commercial | 5.8 | 8.2 | 0.0 | 0.2 | 12.0 | 14.0 | 0.8 | 0.0 | 10.0 | 0.2 |
| Phosphate 1 | | | | | | | | | | |
| Commercial | 25.8 | 30.3 | 0.7 | 3.1 | 15.6 | 19.4 | 0.4 | 2.1 | 22.8 | 1.6 |
| Mixed Oxide | | | | | | | | | | |
| Formulation A | 8.5 | 11.0 | 0.0 | 0.1 | 16.2 | 16.4 | 0.3 | 1.1 | 13.0 | 0.4 |
| Formulation B | 17.3 | 13.2 | 0.0 | 0.2 | 9.1 | 12.2 | 0.8 | 0.0 | 13.0 | 0.3 |
| Formulation C | 11.4 | 12.1 | 0.0 | 0.1 | 11.5 | 14.1 | 0.2 | 0.0 | 12.3 | 0.1 |
| Formulation E | 6.8 | 14.3 | 0.4 | 0.0 | 4.5 | 3.2 | 0.7 | 0.1 | 7.2 | 0.3 |
| Formulation F | 8.3 | 9.1 | 0.2 | 0.6 | 6.7 | 4.4 | 2.1 | 0.7 | 7.1 | 0.9 |

| | | | | | | | | |
|---|---|---|---|---|---|---|---|---|
| Average | 11.7 | 13.2 | 0.3 | 0.5 | 10.8 | 11.1 | 0.7 | 0.6 |

*Average paint loss in mm on duplicate panels
“I” is Commercial Sealing Rinse 3; “II” is Commercial Sealing Rinse 4

Table 3 shows that, on average, Formulations E and F, according to the invention, provided painted panels with at least as good a corrosion protection as commercially available compositions as measured by salt spray performance. Fresh panels treated according to all eight treatment steps recited in Examples 1 and 2, but not exposed to salt spray testing, were subjected to boiling water baths (100 deg. C.) for 60 Minutes. Table 4 shows boiling water adhesion results of painted panels when subjected to reverse impact tests and T-bend testing.

TABLE 4
Boiling Water Test Results

| | Valspar ® Paint System | | | | AKZO ® Paint System | | | | | |
|---|---|---|---|---|---|---|---|---|---|---|
| | 80 in-lb | | T-Bend | | 80 in-lb | | T-Bend | | Average | |
| | Rev. Impact | | Rating* | | Rev. Impact | | Rating* | | Rev. | T- |
| Treatments | I | II | I | II | I | II | I | II | Impact | Bend |
| None | 0% | 0% | 4.8 | 4.8 | 0% | 0% | 3.0 | 4.5 | 0.0% | 4.3 |
| Commercial | 0% | 0% | 4.3 | 4.5 | 0% | 0% | 4.5 | 4.8 | 0.0% | 4.5 |
| Phosphate 1 | | | | | | | | | | |
| Commercial | 0% | 0% | 4.8 | 5.0 | 0% | 0% | 3.8 | 4.8 | 0.0% | 4.6 |
| Phosphate 2 | | | | | | | | | | |
| Formulation A | 0% | 0% | 4.0 | 4.0 | 0% | 0% | 4.0 | 4.0 | 0.0% | 4.0 |
| Formulation B | 0% | 0% | 3.8 | 3.0 | 0% | 0% | 4.3 | 4.0 | 0.0% | 3.8 |
| Formulation C | 1% | 0% | 3.0 | 3.5 | 4% | 1% | 3.3 | 4.3 | 1.5% | 3.5 |
| Formulation E | 2% | 0% | 2.0 | 2.3 | 1% | 1% | 2.5 | 2.8 | 1.0% | 2.4 |
| Formulation F | 0% | 0% | 2.3 | 2.0 | 1% | 1% | 2.8 | 3.3 | 0.5% | 2.6 |

| | | | | | | | | |
|---|---|---|---|---|---|---|---|---|
| Average | 0% | 0% | 3.6 | 3.6 | 1% | 0% | 3.5 | 4.0 |

*Test material is immersed in Boiling Water for 60 min., then evaluated by the T-Bend test. T-Bends are rated 1-5 (5 = No Pick Off), Ratings are the average of 0-T, 1-T, 2-T, and 3-T
“I” is Commercial Sealing Rinse 3; “II” is Commercial Sealing Rinse 4

Reverse impact testing was according ASTM D2794. T-bend testing was according ASTM D4145.

### Example 3

This example was an evaluation of a formulation according to the invention performed on commercial coil coating equipment in industrial facilities. The concentrate was formulated according to Table 5.

TABLE 5

| Raw Materials | Formulation G |
|---|---|
| 75% Phosphoric Acid | 19.40% |
| 67% Nitric Acid | 20.97% |
| 49% Hydrofluoric Acid | 1.60% |
| 49% Zinc Nitrate | 7.20% |
| 50% Hydroxylamine | 1.55% |
| Manganese oxide | 7.75% |
| 13% Cobalt Nitrate | 15.00% |
| Ferric Nitrate | 0.76% |
| Water | remainder |
| | 100.00% |

A working bath was made by using the concentrate of Table 5 at 7% volume/volume and was neutralized to a Free Acid of 3.8 with soda ash. A comparative working bath was made using Comparative Formulation 0 from Table 1 at 7% volume/volume. Commercial grade HDG steel coils were treated and coated according to the following procedure:
1. Cleaned with Parco Cleaner 8686, commercially available from Henkel Corp.;
2. Rinsed with warm water;
3. Activated with Parcolene AT, commercially available from Henkel Corp.;
4. Treated with either Formulation G or Comparative Formulation D;
5. Rinsed with cold water;
6. Sealed with Commercial Sealing Rinse 3 or Commercial Sealing Rinse 4;
7. Primed with a commercially available primer paint used in coil coating lines and baked;
8. Topcoated with a commercially available topcoat used in coil coating lines and baked.

The test results on the painted materials are given in Table 6.

TABLE 6

| | | | | | Boiling Water | | | | | |
|---|---|---|---|---|---|---|---|---|---|---|
| | | | | | Run in <1 | | Run after 4 | | | |
| | | | | | week | | weeks | | | |
| | | | 1008 Hr NSS | | Rev. | | Rev. | | | Color |
| Paint | Pretreat | Rinse | Scribe | Edge | Imp. | T-bend | Imp. | T-bend | CCH | (L) |
| Paint | D | I | 0 mm | 1.4 mm | 0% PL | 4.8 | 0% PL | 4.6 | 10 | 40-50 |
| 1 | G | II | 0 mm | 1.4 mm | 0% PL | 4.9 | 0% PL | 5.0 | 10 | 63 |
| | | I | 0 mm | 1.4 mm | 0% PL | 5.0 | 0% PL | 5.0 | 10 | 61 |
| Paint | | II | 0 mm | 2.8 mm | 0% PL | 3.3 | 0% PL | 4.3 | 10 | 65 |
| 2 | | I | 0 mm | 2.3 mm | 0% PL | 3.3 | 0% PL | 3.9 | 10 | 64 |
| Paint | | II | 0 mm | 2.0 mm | 0% PL | 4.6 | 0% PL | 4.8 | 10 | 64 |
| 3 | | I | 0 mm | 0.9 mm | 0% PL | 4.8 | 0% PL | 4.5 | 10 | 60 |

“I” is Commercial Sealing Rinse 3; “II” is Commercial Sealing Rinse 4
* Sample is immersed Average of 0T, 1T, 2T & 3T Rated 1-5 with 5 = No Pick Off

Panels were cut from the commercial HDG coil roll and were tested for neutral salt spray corrosion resistance according to ASTM B117. Boiling water tests were run for one set of sample panels within 1 week of coating, a second set of sample panels were aged at ambient temperature for 4 weeks and then tested. Instead of reduced performance, which is often seen on panel aging, the 4 week-old panels performed about the same as the newly coated panels in the boiling water test.

Cleveland Condensing Humidity Test, according to ASTM D4585 was performed on fresh sample panels; performance is on a 1-10 scale, 10 being perfect. Color testing for luminosity was performed as described in Example 1. The panels according to the invention provided quantitatively lighter panel luminosity with comparable or better adhesion and corrosion resistance as shown by NSS and boiling water testing.

What is claimed is:

1. A liquid composition of matter useful for forming a phosphate conversion coating on a metal substrate, said liquid composition comprising water and the following components:
(A) dissolved phosphate anions;
(B) about 0.7-4.0 g/L dissolved cobalt cations;
(C) about 0.7-3.0 g/L dissolved zinc cations; and
(D) about 4.5-9.0 g/L dissolved manganese cations;
and optionally one or more of:
(E) a phosphating accelerator that is not part of any of components (A) through (D) as recited immediately above;
(F) dissolved chelating molecules (for divalent metal cations) that are not part of any of components (A) through (E) as recited immediately above;
(G) an acidity adjustment agent that is not part of any of components (A) through (F) as recited immediately above;
(H) dissolved fluoride ions that are not part of any of components (A) through (E) as recited immediately above;
(J) dissolved iron cations and/or dissolved nickel cations, said nickel cations having a concentration of less than <0.5 g/l; and
(K) sludge conditioner that is not part of any of components (A) through (J) as recited immediately above.

2. The liquid composition of matter of claim 1 comprising substantially no nickel cations.

3. The liquid composition of matter of claim 1 comprising:
(A) about 0.2 to 20 wt. % dissolved phosphate anions;
(B) about 0.8-4.0 g/L dissolved cobalt cations;
(C) about 1.0-2.5 g/L dissolved zinc cations; and
(D) about 4.8-9.0 g/L dissolved manganese cations.

4. The liquid composition of matter of claim 1 wherein the weight ratio of manganese to cobalt ranges from 1.0:1.0 to 13:1.

5. The liquid composition of matter of claim 1 wherein the ratio of cobalt to zinc is such that the concentration of cobalt is greater than 50% of the concentration of zinc.

6. The liquid composition of matter of claim 1 comprising a phosphating accelerator and HF.

7. The liquid composition of matter of claim 1 comprising:
(A) about 0.2 to 20 wt. % dissolved phosphate anions;
(B) about 0.8-4.0 g/L dissolved cobalt cations;
(C) about 1.0-2.5 g/L dissolved zinc cations;
(D) about 5.0-9.0 g/L dissolved manganese cations;
(E) a phosphating accelerator that is not part of any of components (A) through (D) as recited immediately above;
(G) an acidity adjustment agent that is not part of any of components (A) through (F) as recited immediately above;
(H) dissolved fluoride ions that are not part of any of components (A) through (E) as recited immediately above;
(J) dissolved iron cations and/or dissolved nickel cations, said nickel cations having a concentration of less than <0.5 g/l.

8. The liquid composition of matter of claim 7 comprising at least 6.0 g/1 manganese.

9. The liquid composition of matter of claim 8 comprising iron cations, HF and nitrate ions.

10. A process for producing a phosphate conversion coating on a metal substrate, said process comprising:
contacting a metal substrate with a liquid phosphating composition for a sufficient time and at a sufficient temperature to form a phosphate conversion coated metal substrate, said liquid phosphating composition comprising water and the following components:
(A) sufficient dissolved phosphate anions to deposit a phosphate coating;
(B) about 0.7-4.0 g/L dissolved cobalt cations;
(C) about 0.7-3.0 g/L dissolved zinc cations; and
(D) about 4.5-9.0 g/L dissolved manganese cations;
and optionally one or more of:
(E) a phosphating accelerator that is not part of any of components (A) through (D) as recited immediately above;
(F) dissolved chelating molecules (for divalent metal cations) that are not part of any of components (A) through (E) as recited immediately above;
(G) an acidity adjustment agent that is not part of any of components (A) through (F) as recited immediately above;
(H) dissolved fluoride ions that are not part of any of components (A) through (E) as recited immediately above;
(J) dissolved iron cations and/or dissolved nickel cations, said nickel cations having a concentration of less than <0.5 g/l; and
(K) sludge conditioner that is not part of any of components (A) through (J) as recited immediately above;
optionally rinsing the phosphate conversion coated metal substrate.

11. The process of claim 10 wherein the metal substrate comprises zinciferous metal substrates.

12. The process of claim 10 comprising the further step of maintaining concentrations of phosphate anions, cobalt cations, zinc cations and manganese cations in said composition such that the phosphate conversion coating deposited on said metal substrate comprises phosphorus, oxygen, zinc, at least 5.0 wt. % manganese and at least 0.5 wt % cobalt.

13. The process of claim 10 wherein the contacting time is not more than 45 seconds.

14. The process of claim 10 wherein said composition comprises:
(A) about 0.2 to 20 wt. % dissolved phosphate anions;
(B) about 0.8-4.0 g/L dissolved cobalt cations;
(C) about 1.0-2.5 g/L dissolved zinc cations; and
(D) about 5.0-9.0 g/L dissolved manganese cations.

15. The process of claim 10 wherein the weight ratio of manganese to cobalt in said composition ranges from 1.0:1:0 to 13:1.

16. The process of claim 10 wherein the ratio of cobalt to zinc in said composition is such that the concentration of cobalt is greater than 50% of the concentration of zinc.

17. An article of manufacture comprising a metal substrate and a phosphate conversion coating deposited on said metal substrate, said phosphate conversion coating comprising zinc, manganese and cobalt; said coating having an “L” value of at least 60, an “a” value of not more than 3 and a “b” value of not more than 3.

18. The article of manufacture of claim 17, said phosphate conversion coating comprising phosphorus, oxygen, zinc, at least 5.0 wt. % manganese and at least 0.5 wt % cobalt.

19. An article of manufacture comprising a metal substrate and a phosphate conversion coating deposited on said metal substrate, said phosphate conversion coating comprising phosphorus, oxygen, zinc, at least 5.0 wt. % manganese and at least 0.5 wt % cobalt.
